(19) United States
(12) Patent Application Publication
(10) Pub. No.: US 2026/0312106 A1
(43) Pub. Date: Oct. 8, 2026

(54) MEMBRANE ELECTRODE ASSEMBLY WITH PROTECTED EDGES

(71) Applicant: GM GLOBAL TECHNOLOGY OPERATIONS LLC, Detroit, MI (US)

(72) Inventors: Swaminatha P. KUMARAGURU, Rochester Hills, MI (US); Richard WEHBE, Berkley, MI (US)

(21) Appl. No.: 19/173,255

(22) Filed: Apr. 8, 2025

(51) Int. Cl. H01M 8/1004; H01M 4/88; H01M 8/0271

(52) U.S. Cl. CPC H01M 8/1004; H01M 4/8807; H01M 4/8825; H01M 4/8878; H01M 8/0271

(57) ABSTRACT

A method for manufacturing a membrane electrode assembly includes a) patch coating a plurality of anode electrode layers spaced from one another on a first gas diffusion layer; b) patch coating a plurality of cathode electrode layers spaced from one another on a second gas diffusion layer; c) cutting a continuous membrane into a plurality of membrane layers; d) stacking the plurality of membrane layers onto one of: the plurality of cathode electrode layers; and the plurality of anode electrode layers; and e) laminating the plurality of cathode and anode electrode layers, the plurality of membrane layers, and a plurality of gasket layers between the first and second gas diffusion layers, respectively. Opposing outer edges of the plurality of membrane layers and the plurality of cathode and anode electrode layers are located inwardly from opposing outer edges of the first gas diffusion layer and the second gas diffusion layer.

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to fuel cells, and more particularly to a membrane electrode assembly with protected edges.

Fuel cells can be used to provide power to a load. Fuel cells include anode electrode layers, cathode electrode layers, and a polymer electrolyte membrane (PEM). The polymer electrolyte membrane is arranged between the cathode and anode electrode layers. Molecular hydrogen (H₂) is supplied to the anode electrode layer and molecular oxygen (O₂) is supplied to the cathode electrode layer. Hydrogen ions (H⁺) pass through the PEM. Electrons (e⁻) pass through an external circuit such as a load producing current through the load. Fuel cells can be used to supply power to electric vehicles and/or for stationary applications. While a catalyst coated membrane approach is more prevalent, high volume manufacturing processes such as gas diffusion electrode (GDE) or catalyst coated on diffusion media (CCDM) in a roll-to-roll process are gaining prevalence.

### SUMMARY

A method for manufacturing a membrane electrode assembly includes a) patch coating a plurality of anode electrode layers spaced from one another on a first gas diffusion layer; b) patch coating a plurality of cathode electrode layers spaced from one another on a second gas diffusion layer; c) cutting a continuous membrane into a plurality of membrane layers; d) stacking the plurality of membrane layers onto one of: the plurality of cathode electrode layers; and the plurality of anode electrode layers; and e) laminating the plurality of cathode electrode layers, the plurality of anode electrode layers, the plurality of membrane layers, and a plurality of gasket layers between the first gas diffusion layer and the second gas diffusion layer, respectively. Opposing outer edges of the plurality of membrane layers, the plurality of cathode electrode layers, and the plurality of anode electrode layers are located inwardly from opposing outer edges of the first gas diffusion layer and the second gas diffusion layer.

In other features, prior to d), cutting at least one of the plurality of anode electrode layers and the first gas diffusion layer; and the plurality of cathode electrode layers and the second gas diffusion layer.

In other features, after d), cutting at least one of the anode electrode layers and the first gas diffusion layer; and the cathode electrode layers and the second gas diffusion layer.

In other features, the method includes aligning the opposing outer edges of the plurality of membrane layers, the plurality of cathode electrode layers, and the plurality of anode electrode layers in first and second transverse directions.

In other features, the method includes aligning the opposing outer edges of the plurality of membrane layers and the plurality of anode electrode layers; and locating the opposing outer edges of the cathode electrode layers inwardly from the outer edges of the plurality of membrane layers and the plurality of anode electrode layers.

In other features, the plurality of gasket layers are arranged between the plurality of anode electrode layers and the plurality of membrane layers, respectively. The plurality of gasket layers are arranged between the plurality of cathode electrode layers and the plurality of membrane layers, respectively.

A method for manufacturing a membrane electrode assembly includes a) continuous coating a plurality of anode electrode layers longitudinally on a first gas diffusion layer; b) continuous coating a plurality of cathode electrode layers longitudinally on a second gas diffusion layer; c) cutting a continuous membrane into a plurality of membrane layers; d) stacking the plurality of membrane layers onto one of: the plurality of cathode electrode layers; and the plurality of anode electrode layers; and, e) laminating the plurality of cathode electrode layers, the plurality of anode electrode layers, the plurality of membrane layers, and a plurality of gasket layers between the first gas diffusion layer and the second gas diffusion. Opposing outer edges of the plurality of membrane layers, the plurality of cathode electrode layers, and the plurality of anode electrode layers are located inwardly from opposing outer edges of the first gas diffusion layer and the second gas diffusion layer in a first direction.

In other features, prior to d), cutting at least one of the plurality of anode electrode layers and the first gas diffusion layer; and the plurality of cathode electrode layers and the second gas diffusion layer.

In other features, after d), cutting at least one of the anode electrode layers and the first gas diffusion layer; and the cathode electrode layers and the second gas diffusion layer.

In other features, the method includes aligning the opposing outer edges of the plurality of cathode electrode layers and the plurality of anode electrode layers in a second direction transverse to the first direction; and locating the opposing outer edges of the plurality of membrane layers inwardly from the outer edges of the plurality of cathode electrode layers and the plurality of anode electrode layers in the second direction.

In other features, the plurality of gasket layers are arranged between the plurality of anode electrode layers and the plurality of membrane layers, respectively. The plurality of gasket layers are arranged between the plurality of cathode electrode layers and the plurality of membrane layers, respectively.

A membrane electrode assembly includes a first gas diffusion layer; an anode electrode layer arranged adjacent to the first gas diffusion layer; a gasket layer; a membrane layer; a cathode electrode layer; and a second gas diffusion layer arranged adjacent to the cathode electrode layer. Opposing outer edges of the membrane layer are located inwardly from corresponding opposing outer edges of the first gas diffusion layer and the second gas diffusion layer.

In other features, one set of the opposing outer edges of the membrane layer is aligned with corresponding outer edges of the cathode electrode layer and the anode electrode layer. The other set of the opposing outer edges of the membrane layer is aligned with corresponding outer edges of the cathode electrode layer and the anode electrode layer.

In other features, one set of the opposing outer edges of the membrane layer is located inwardly relative to corresponding outer edges of at least one of the cathode electrode layer and the anode electrode layer.

In other features, the other set of the opposing outer edges of the membrane layer is located inwardly relative to corresponding outer edges of at least one of the cathode electrode layer and the anode electrode layer.

In other features, one set of the opposing outer edges of the membrane layer is located outwardly from first and second opposed outer edges of the cathode electrode layer.

In other features, one set of the opposing outer edges of the membrane layer is aligned with corresponding outer edges of the cathode electrode layer and the anode electrode layer in a first direction. In a second direction transverse to the first direction, the other set of the opposing outer edges of the membrane layer is located inwardly from corresponding outer edges of the cathode electrode layer.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1A is a functional block diagram of an example of a membrane electrode assembly according to the present disclosure;

FIG. 1B is a functional block diagram of an example of a fuel cell stack including a plurality of membrane electrode assemblies arranged between adjacent bipolar plates according to the present disclosure;

FIG. 2 is a plan view illustrating an example of a continuous gas diffusion electrode layer with patch coated cathode electrode layers according to the present disclosure;

FIG. 3 is a plan view illustrating an example of a continuous membrane layer cut into discrete membrane layers according to the present disclosure;

FIGS. 4 and 5 illustrate an example of lamination of the membrane layers onto the cathode electrode layer/gas diffusion layer (GDL) according to the present disclosure;

FIGS. 6A and 6B illustrate an example of lamination of the membrane layer/cathode electrode layer/GDL, anode electrode layer/GDL, and gasket layer according to the present disclosure;

FIG. 7 is a cross section of an example of the membrane electrode assembly in machine and/or cross-machine directions after lamination according to the present disclosure;

FIG. 8 is a cross section of an example of the membrane electrode assembly in machine and/or cross-machine directions after lamination according to the present disclosure;

FIG. 9 is a flowchart of an example of a method for manufacturing a membrane electrode assembly according to the present disclosure;

FIG. 10 is a plan view illustrating an example of a continuous gas diffusion electrode layer with continuous coated cathode electrode layers according to the present disclosure;

FIG. 11 is a plan view illustrating an example of a continuous membrane layer cut into discrete membrane layers according to the present disclosure;

FIGS. 12 and 13 illustrate an example of lamination of the membrane layer onto the cathode electrode layer/gas diffusion layer (GDL) according to the present disclosure;

FIG. 14 illustrates an example of lamination of the membrane layer/cathode electrode layer/GDL, anode electrode layer/GDL, and gasket layer according to the present disclosure;

FIG. 15 is a cross section of an example of the membrane electrode assembly in a machine direction after lamination according to the present disclosure;

FIG. 16 is a cross section of an example of the membrane electrode assembly in a cross-machine direction after lamination according to the present disclosure; and

FIG. 17 is a flowchart of another example of a method for manufacturing a membrane electrode assembly according to the present disclosure.

In the drawings, reference numbers may be reused to identify similar and/or identical elements.

### DETAILED DESCRIPTION

While the membrane electrode assemblies are described below in the context of fuel cells for vehicles, the membrane electrode assemblies can be used in other applications such as fuel cells for stationary applications and other electrochemical cells such as PEM water electrolyzer for hydrogen production.

Membrane electrode assemblies can be manufactured using high volume roll-to-roll manufacturing and the gas diffusion electrode (GDE) approach. Conventional membrane electrode assemblies manufactured using the GDE approach experience external contamination due to the edge design. In these designs, opposing outer edges of a gas diffusion layer (GDL), an anode electrode layer, a cathode electrode layer, and a membrane layer are aligned. In other words, these layers maintain the same outer dimensions.

The membrane electrode assemblies are arranged between bipolar plates that are made of metal such as stainless steel. Corrosion of the bipolar plates can cause metal ions such as iron (Fe²⁺) to be released. While the hydrophobic gas diffusion layer repels water and thereby limits Fe²⁺ pathways into the MEA, the exposed membrane at the edge offers a pathway for Fe²⁺ to enter the MEA. Fe2+ (a known Fenton’s agent) accelerates undesired reactions such as decomposing hydrogen peroxide to hydroxide (●OH) radicals, which leads to rapid degradation of the membrane and reduces durability.

While hydroxide radical scavengers like Ce³⁺ and/or Mn²⁺ added in the membrane provide some mitigation, arrival of Fe²⁺ into the MEA leads to membrane failure. In some examples the gasket is arranged between the anode electrode and the membrane (leading to cathode larger than the anode electrode). The radical scavenger cations (Ce³⁺ and Mn²⁺) are driven by potential gradients and tend to build up under the gasket at outer edges of the GDLs, the anode electrode layer, the cathode electrode layer, and the membrane layer causing additional performance or durability issues.

The membrane electrode assemblies according to the present disclosure include a membrane layer and electrode layers that have smaller dimensions (opposing outer edges that are recessed relative to first and/or second sets of opposing outer edges of the GDLs). In a first manufacturing method, patch coating is used to coat the anode and cathode electrode layers in a spaced relationship on the GDL. An uncoated GDL region is located along opposing outer edges in a machine direction and cross machine direction. A membrane layer is cut to size and laminated onto the electrode layer/GDL such that opposing outer edges of the GDLs are larger and located outwardly from opposing outer edges of the membrane and electrode layers in both machine and cross machine direction. The membrane layer can be the same size as the electrode layer or larger than the electrode layer but smaller than the GDLs.

In another method, an electrode layer is continuously coated onto a GDL layer in a roll-to-roll process. An uncoated GDL region is located along opposing edges in a machine direction. A membrane layer is cut and laminated onto the electrode layer/GDL. Opposing outer edges of the GDLs are larger than and located outwardly from the opposing outer edges of electrode layer and membrane layer in machine direction. Opposing outer edges of the electrode and membrane layers are aligned in a machine direction. Opposing outer edges of the membrane layer are located inwardly from the cathode electrode layer in a cross machine direction.

Manufacturing can be accomplished via roll-to-roll or discrete manufacturing methods using these approaches.

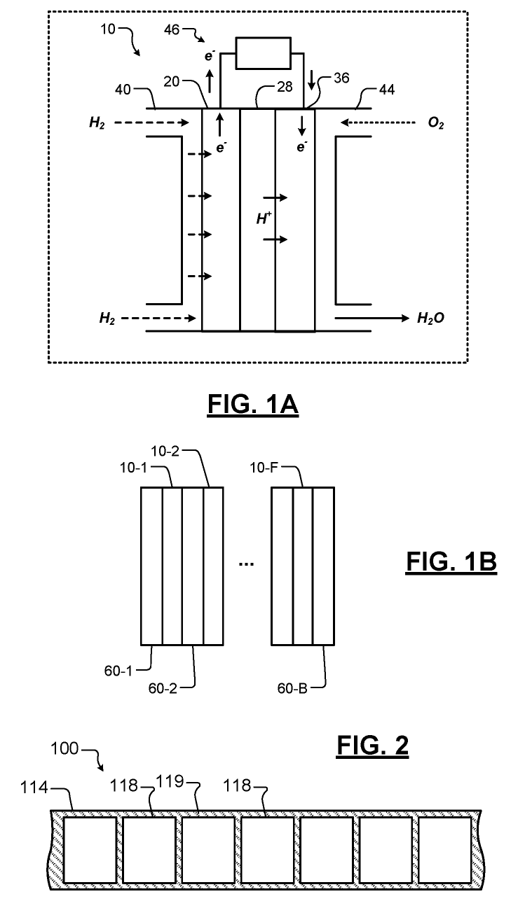

Referring now to FIG. 1A, a fuel cell 10 includes an anode electrode layer 20, a membrane layer 28, and a cathode electrode layer 36. Gas diffusion layers 40 and 44 are arranged adjacent to the anode electrode layer 20 and the cathode electrode layer 36, respectively. Molecular hydrogen (H₂) is supplied to the gas diffusion layer 40 of the anode electrode layer 20. Molecular oxygen (O₂) is supplied to the gas diffusion layer 44 of the cathode electrode layer 36. A hydrogen oxidation reaction (HOR) occurs at the anode electrode layer 20, hydrogen gas (H₂) is split into protons (H⁺) and electrons (e⁻). The membrane layer 28 passes hydrogen ions (H⁺) to the cathode electrode layer 36. Electrons (e-) pass through an external circuit 46 such as a load or battery to the cathode electrode layer. An oxygen reduction reaction (ORR) occurs at the cathode electrode layer 36, molecular oxygen (O₂), hydrogen ions (H⁺) and electrode layer (e⁻) react to form water (H₂O).

Cathode (reduction): 2H⁺ + 2e⁻ +1/2 O₂(g) →H₂O(l); and

Anode (oxidation): H₂(g) →2 H⁺ + 2e⁻.

Overall: 2H₂(g) + O₂(g) →2H₂O(l)

Referring now to FIG. 1B, the MEAs 10-1, 10-2, …, and 10-F are located between adjacent bipolar plates 60-1, 60-2, …, and 60-B, where F and B are integers greater than one. In some examples, the bipolar plates 60-1, 60-2, …, and 60-B include channels, ports, and a central window (not shown) (some of which are aligned with ports and windows of the gasket layers described further below). In some examples, the bipolar plate is made of stainless steel that is a source of iron ions or other metal ions during corrosion.

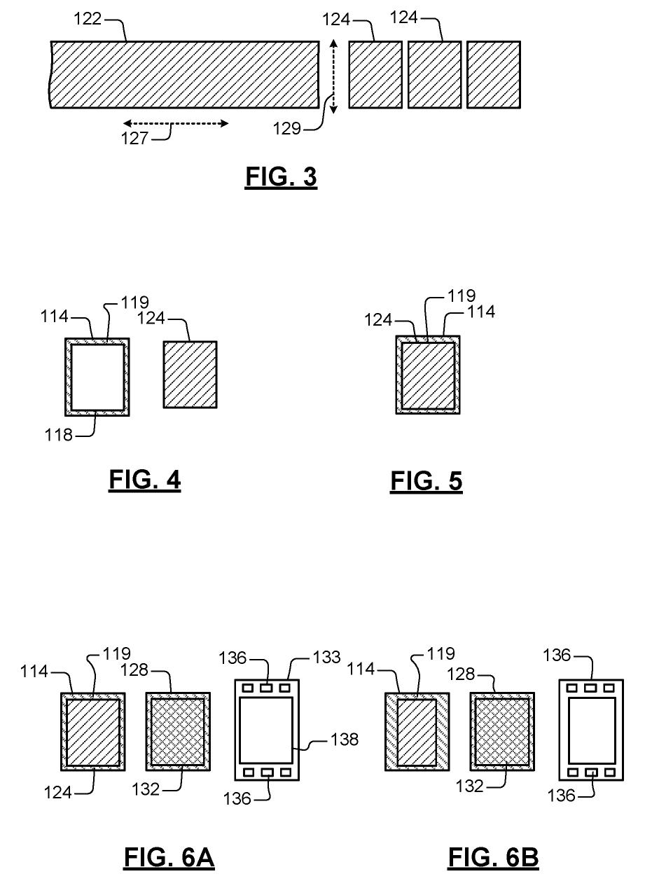

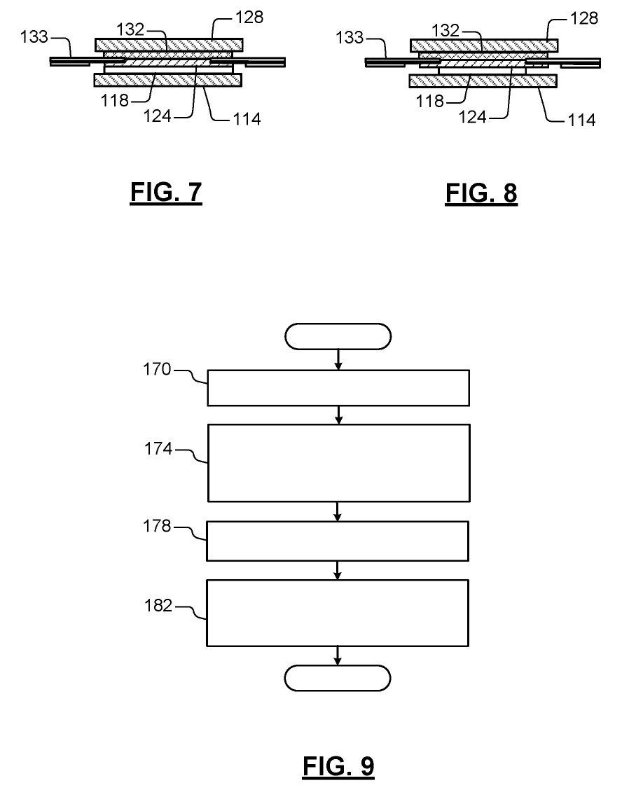

Referring now to FIGS. 2-9, a method for manufacturing a membrane electrode assembly is shown. In FIG. 2, patch coating is used to coat a continuous gas diffusion layer (GDL) 114 with cathode electrode layers 118 that are spaced apart. An edge region 119 of the GDL 114 in both machine direction and cross machine direction is not coated. In FIG. 3, a continuous membrane layer 122 is cut and sized into discrete membrane layers 124. In some examples, the membrane layers 124 are the same size as the cathode electrode layers 118 (or anode electrode layers 132) (e.g., as shown in FIG. 7) in a machine direction (arrow 127) and/or a cross-machine direction (arrow 129). In other examples, the membrane layers 124 are larger than the cathode electrode layers 118 but smaller than the GDLs 114 in the machine direction and/or the cross-machine direction (as shown in FIG. 8).

In FIGS. 4 and 5, the membrane layers 124 are aligned and laminated onto the cathode electrode layers 118/GDLs 114. For example, the membrane layers 124 can be aligned with one or both edges of the cathode electrode layers 118. A similar approach is used to patch coat a gas diffusion layer (GDL) 128 with anode electrode layers 132 that are spaced apart.

In FIG. 6A, the membrane layer 124, the cathode electrode layer 118 and the anode electrode layer 132 have the same dimensions in the machine and cross machine directions. In FIG. 6B, the cathode electrode layer 118 is the same size as or narrower than the membrane layer 124 and the anode electrode layer 132 in the machine direction and cross machine direction. The membrane layer 124/cathode electrode layers 118/GDLs 114, a gasket layer 133 (including ports 136 and a window 138), and anode electrode layers 132/GDLs 128 are laminated together. In certain examples, the gasket layer contains an adhesive layer in the edges facing the membrane.

In FIG. 7, a cross section of the membrane electrode assembly is shown in machine and/or cross machine directions. In this example, edges of the cathode electrode layers 118, the membrane layers 124, and the anode electrode layers 132 are aligned and arranged inwardly from outer edges of the GDLs 114 and 128. In some examples, the GDLs 114 and 128 are significantly thicker than the membrane layer 124 and the electrode layers (GDLs are in a range from 5 to 15 times thicker than electrode and membrane layers). The GDL 114 and 128 are also compressible materials. (for example, Sigracet^{TM}39BB GDL has an uncompressed thickness of about ~300 um vs. compressed thickness of ~220 um @ 1MPa). As a result, the GDLs 114 and 128 protect edges of the electrode layers and membrane layers when the membrane electrode assembly is compressed between the bipolar plates. In this example, the gasket layer 133 is located between the membrane layer 124 and the anode electrode layer 132. Further the adhesive in the gasket facing the membrane bonds with membrane and uncoated GDL edge forming a protected edge. As can be appreciated, the gasket layer 133 can be located between the membrane layer 124 and the cathode electrode layer 118.

In FIG. 8, a cross section of the membrane electrode assembly is shown in machine and/or cross-machine directions. In this example, edges of the cathode electrode layers 118, the membrane layer 124, and the anode electrode layer 132 are arranged inwardly from outer edges of the GDLs 114 and 128. As before, the GDLs 114 and 128 protect edges of the electrode layers and membrane layers when the membrane electrode assembly is compressed between the bipolar plates. In some examples, outer edges of the cathode electrode layer 118 are arranged inwardly of the membrane layer 124 and the anode electrode layer 132 in the machine and cross machine directions. In some examples, the width of the cathode electrode layer 118 is greater than or equal to the width of the window 138. By limiting the size of cathode electrode in relation to the subgasket window and by extension the anode electrode, the potential gradient that favors accumulation of metal cations including the Ce³⁺ and Mn²⁺ radical scavengers is reduced. This prevents the accumulation of the metal cations under the subgasket and near GDL edges while providing protection from external Fe²⁺ through protected edge. .

In FIG. 9, a method for manufacturing a membrane electrode assembly is shown. At 170, patch coating is used to coat cathode electrode layers 118 that are spaced apart from one another on a continuous gas diffusion layer (GDL) 114. A similar approach is used to patch coat anode electrode layers 132 that are spaced apart on a gas diffusion layer (GDL) 128. At 174, a continuous membrane layer 122 is sized and cut into discrete membrane layers 124. At 178, the membrane layers 124 are aligned with and laminated onto the cathode electrode layers 118 (which is arranged on the GDL 114). At 182, the membrane layer 124/cathode electrode layers 118/GDLs 114, a gasket layer 133 (including ports 136 and a window 138), and anode electrode layers 132/GDL 128 are laminated together.

While an example of the discrete approach is shown, with advanced location techniques, the discreet membrane parts can be laminated on the patch coated roll with similar layup and dimensions followed by slitting and lamination with the sub-gasket. In some examples, this process can be implemented using a roll-roll process.

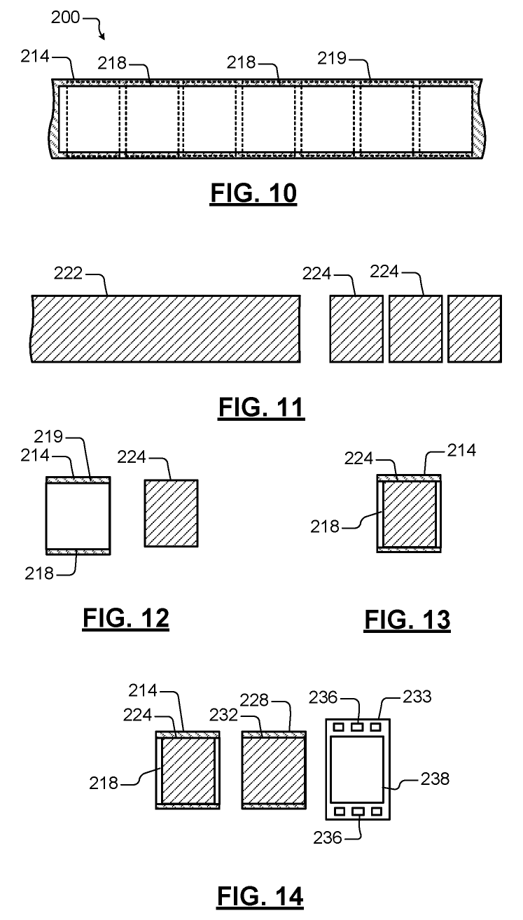

Referring now to FIGS. 10-17, a method for manufacturing a membrane electrode assembly is shown. In FIG. 10, continuous coating is used to coat a continuous cathode electrode layer (that is later separated into discrete cathode electrode layers 218) on a continuous gas diffusion layer (GDL) 214. Uncoated GDL regions 219 are located along opposite edges in a machine direction. The anode electrode layers are manufactured using a similar approach. In FIG. 11, a continuous membrane layer 222 is sized and cut into discrete membrane layers 224. In some examples, the membrane layers 224 are the same size as the cathode electrode layers 218 in a cross section transverse to the machine direction. In some examples, the membrane layers 224 are smaller than the cathode electrode layers 218 (which are smaller than the GDL 214) in a cross section transverse to the cross-machine direction.

In FIGS. 12 and 13, the membrane layers 224 are aligned and laminated onto the cathode electrode layer 218/GDL 214. For example, opposing edges of the membrane layers 224 can be aligned with opposing edges of the cathode electrode layers 218 in the machine direction and offset inwardly in the cross machine direction. A similar approach is used to continuous coat anode electrode layers 232 that are spaced apart on a gas diffusion layer (GDL) 228.

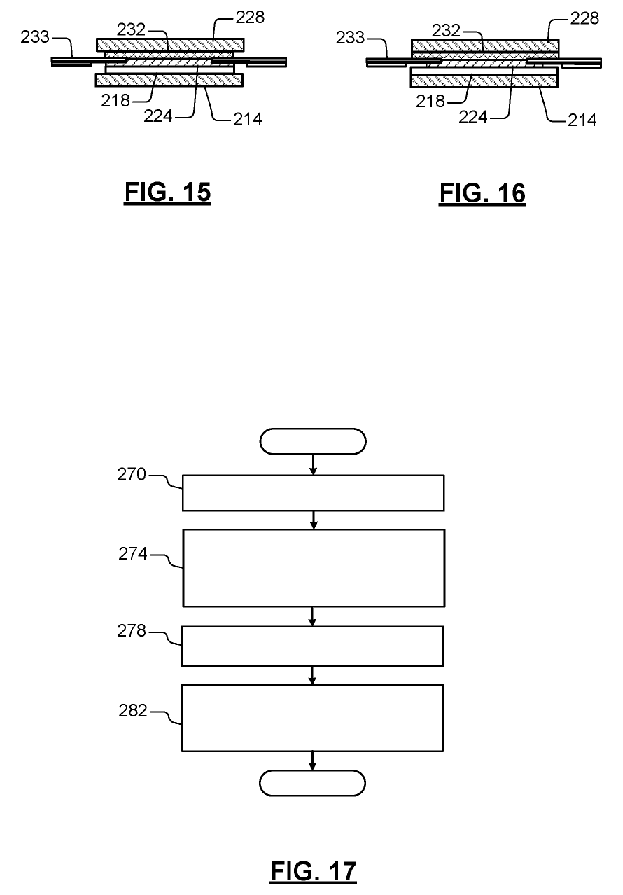

In FIGS. 14 and 15, the membrane 224/cathode electrode layers 218/GDLs 214, a gasket layer 233 (including ports 236 and a window 238), and anode electrode layers 232/GDLs 228 are laminated together. In FIGS. 15, a cross section of the membrane electrode assembly is shown in a machine direction. Opposing outer edges of the cathode electrode layers 218, the membrane layer 224, and the anode electrode layer 232 are aligned and arranged inwardly from opposing outer edges of the GDLs 214 and 228. The window 238 of the gasket layer 233 is located between the membrane layer 224 and the anode electrode layer 232 (or the cathode electrode layer 218). In some examples, as viewed from a transverse cross section of the machine direction, the outer edges of the cathode layer 218 are arranged inwardly of the membrane layer 224 and the anode electrode layer 132. In some examples, the outer edge of the cathode layer 218 is same as the edge of the gasket window 238. This reduces the size of cathode electrode in relation to anode electrode there by preventing the accumulation of peroxide scavenger metal cations (Ce³⁺ and Mn²⁺) under the subgasket near GDL edge in the machine direction.

In FIG. 16, a cross section of the membrane electrode assembly is shown in a cross-machine direction. Opposing outer edges of the membrane layer 224 are arranged inwardly from opposing outer edges of the cathode electrode layer 218, anode electrode layer 232 and GDLs 214 and 228. .

In some examples, the GDLs 214 and 228 are significantly thicker and compressible and the sub-gasket has an adhesive layer along edges of the window on the surface facing the membrane. When the MEA is laminated as well as during stack compression, the uncoated GDL edge will attach to the gasket in the machine direction providing protection from external incoming Fe²⁺. Partial protection is achieved in cross machine direction as electrode edge attaches to the subgasket and electrode edge is exposed for Fe²⁺. Albeit the Fe²⁺ migration into MEA through electrode edge will be slower due to reduced amount of ion conducting pathways in electrode in comparison to membrane. In some examples, the protected machine direction edge is located to the cathode inlet ports where prevalence of Fe2⁺ can be high.

In FIG. 17, a method for manufacturing a membrane electrode assembly is shown. At 270, continuous coating is used to coat a continuous gas diffusion layer (GDL) 114 with a continuous cathode layer (subsequently cut into cathode electrode layers 118). A similar approach is used to coat a gas diffusion layer (GDL) 228 with anode electrode layers 232. At 274, a continuous membrane layer 222 is cut into discrete membrane layers 224 that are the same size or smaller than the cathode electrode layers 218 and anode electrode layers 232. At 278, the membrane layers 224 are aligned with and laminated onto the cathode electrode layers 218 (which is arranged on the GDLs 214). At 282, the membrane 224/cathode electrode layers 218/GDLs 214, a gasket layer 233 (including ports 236 and a window 238), and anode electrode layers 232/GDL 228 are laminated together.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

What is claimed is:

1. A method for manufacturing a membrane electrode assembly, comprising:
a) patch coating a plurality of anode electrode layers spaced from one another on a first gas diffusion layer;
b) patch coating a plurality of cathode electrode layers spaced from one another on a second gas diffusion layer;
c) cutting a continuous membrane into a plurality of membrane layers;
d) stacking the plurality of membrane layers onto one of:
the plurality of cathode electrode layers; and
the plurality of anode electrode layers; and
e) laminating the plurality of cathode electrode layers, the plurality of anode electrode layers, the plurality of membrane layers, and a plurality of gasket layers between the first gas diffusion layer and the second gas diffusion layer, respectively,
wherein opposing outer edges of the plurality of membrane layers, the plurality of cathode electrode layers, and the plurality of anode electrode layers are located inwardly from opposing outer edges of the first gas diffusion layer and the second gas diffusion layer.

2. The method of claim 1, further comprising, prior to d), cutting at least one of:
the plurality of anode electrode layers and the first gas diffusion layer; and
the plurality of cathode electrode layers and the second gas diffusion layer.

3. The method of claim 1, further comprising, after d), cutting at least one of:
the anode electrode layers and the first gas diffusion layer; and
the cathode electrode layers and the second gas diffusion layer.

4. The method of claim 1, further comprising aligning the opposing outer edges of the plurality of membrane layers, the plurality of cathode electrode layers, and the plurality of anode electrode layers in first and second transverse directions.

5. The method of claim 1, further comprising:
aligning the opposing outer edges of the plurality of membrane layers and the plurality of anode electrode layers; and
locating the opposing outer edges of the cathode electrode layers inwardly from the outer edges of the plurality of membrane layers and the plurality of anode electrode layers.

6. The method of claim 1, wherein the plurality of gasket layers are arranged between the plurality of anode electrode layers and the plurality of membrane layers, respectively.

7. The method of claim 1, wherein the plurality of gasket layers are arranged between the plurality of cathode electrode layers and the plurality of membrane layers, respectively.

8. A method for manufacturing a membrane electrode assembly, comprising:
a) continuous coating a plurality of anode electrode layers longitudinally on a first gas diffusion layer;
b) continuous coating a plurality of cathode electrode layers longitudinally on a second gas diffusion layer;
c) cutting a continuous membrane into a plurality of membrane layers;
d) stacking the plurality of membrane layers onto one of:
the plurality of cathode electrode layers; and
the plurality of anode electrode layers; and
e) laminating the plurality of cathode electrode layers, the plurality of anode electrode layers, the plurality of membrane layers, and a plurality of gasket layers between the first gas diffusion layer and the second gas diffusion layer,
wherein opposing outer edges of the plurality of membrane layers, the plurality of cathode electrode layers, and the plurality of anode electrode layers are located inwardly from opposing outer edges of the first gas diffusion layer and the second gas diffusion layer in a first direction.

9. The method of claim 8, further comprising, prior to d), cutting at least one of:
the plurality of anode electrode layers and the first gas diffusion layer; and
the plurality of cathode electrode layers and the second gas diffusion layer.

10. The method of claim 8, further comprising, after d), cutting at least one of:
the anode electrode layers and the first gas diffusion layer; and
the cathode electrode layers and the second gas diffusion layer.

11. The method of claim 8, further comprising:
aligning the opposing outer edges of the plurality of cathode electrode layers and the plurality of anode electrode layers in a second direction transverse to the first direction; and
locating the opposing outer edges of the plurality of membrane layers inwardly from the outer edges of the plurality of cathode electrode layers and the plurality of anode electrode layers in the second direction.

12. The method of claim 8, wherein the plurality of gasket layers are arranged between the plurality of anode electrode layers and the plurality of membrane layers, respectively.

13. The method of claim 8, wherein the plurality of gasket layers are arranged between the plurality of cathode electrode layers and the plurality of membrane layers, respectively.

14. A membrane electrode assembly comprising:
a first gas diffusion layer;
an anode electrode layer arranged adjacent to the first gas diffusion layer;
a gasket layer;
a membrane layer;
a cathode electrode layer; and
a second gas diffusion layer arranged adjacent to the cathode electrode layer,
wherein opposing outer edges of the membrane layer are located inwardly from corresponding opposing outer edges of the first gas diffusion layer and the second gas diffusion layer.

15. The membrane electrode assembly of claim 14, wherein one set of the opposing outer edges of the membrane layer is aligned with corresponding outer edges of the cathode electrode layer and the anode electrode layer.

16. The membrane electrode assembly of claim 15, wherein the other set of the opposing outer edges of the membrane layer is aligned with corresponding outer edges of the cathode electrode layer and the anode electrode layer.

17. The membrane electrode assembly of claim 14, wherein one set of the opposing outer edges of the membrane layer is located inwardly relative to corresponding outer edges of at least one of the cathode electrode layer and the anode electrode layer.

18. The membrane electrode assembly of claim 17, wherein the other set of the opposing outer edges of the membrane layer is located inwardly relative to corresponding outer edges of at least one of the cathode electrode layer and the anode electrode layer.

19. The membrane electrode assembly of claim 14, wherein one set of the opposing outer edges of the membrane layer is located outwardly from first and second opposed outer edges of the cathode electrode layer.

20. The membrane electrode assembly of claim 14, wherein:
one set of the opposing outer edges of the membrane layer is aligned with corresponding outer edges of the cathode electrode layer and the anode electrode layer in a first direction, and
in a second direction transverse to the first direction, the other set of the opposing outer edges of the membrane layer is located inwardly from corresponding outer edges of the cathode electrode layer.
